(19) United States
(12) Patent Application Publication
(10) Pub. No.: US 2007/0240814 A1
(43) Pub. Date: Oct. 18, 2007

(54) Through-hole machining apparatus of green sheet and through-hole machining method of the same

(75) Inventors: Yuji Sakuma, Fukushima-ken (JP); Seiichi Yokoyama, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/784,323

(22) Filed: Apr. 5, 2007

(30) Foreign Application Priority Data
Apr. 13, 2006 (JP) 2006-111190
Jun. 14, 2006 (JP) 2006-164701
Jan. 18, 2007 (JP) 2007-009066

(51) Int. Cl. B32B 38/04; B26F 1/14

(52) U.S. Cl. 156/252; 83/687; 83/698.21

(57) ABSTRACT

There is provided a green sheet through-hole machining apparatus, and a through-hole machining method, that allows deterioration of positional precision of through-holes after perforation to be readily prevented. A releasing plate made of a metallic thin plate is removably set on an upper face of a lower base. Then, a green sheet is interposed between the lower and upper bases and the upper base is pressed by a pressurizing roller to press the green sheet toward the releasing plate. Then, the green sheet is punched by the projections to perforate the through-holes. After that, the green sheet is removed from the lower base together with the releasing plate.

### BACKGROUND OF THE INVENTION

1. Field of the Invention

The present invention relates to a machining apparatus for use in perforating through-holes through a ceramic green sheet and to a through-hole machining method of the same.

2. Description of the Related Art

A green sheet formed of green ceramic is prepared at first in general in a procedure for manufacturing a ceramic multi-layered wiring board. Then, after perforating through-holes through predetermined positions of the green sheet, conductive paste is filled into those through-holes and a wiring pattern is screen-printed on a surface of the green sheet. After that, a required number of green sheets is laminated and sintered to form the multi-layered wiring board.

A machining apparatus for use in perforating the through-holes through the green sheet is normally provided with a lower base that corresponds to a punch and an upper base that corresponds to a die and is arranged so as to perforate the through-holes through the green sheet using projections of the lower base by applying pressure from above while interposing the green sheet between the upper and lower dies. That is, the lower base is provided with the projections for perforating the through-holes at a plurality of spots on an upper face thereof and the upper base is provided with a plurality of transmission holes for inserting the group of projections. Therefore, the machining apparatus can punch through the green sheet by the projections of the lower base to form the through-holes by pressing down the green sheet by applying pressure to the upper base using a pressurizing roller after interposing the green sheet between the lower and upper bases (see Japanese Patent Publication No. 1990-4152 for example). After that, the green sheet that has been removed from the lower base is conveyed to a stage of a next step.

Note that an adhesive tape is interposed between the upper base and the pressurizing roller, so that chips of the green sheet punched using the projections of the lower base are pushed into the transmission holes of the upper base and are removed by the adhesive tape.

Because the operation for pressing the upper base is performed in a state in which a lower face of the green sheet faces the upper face of the lower base in the process for forming the through-holes in the conventional art described above, the green sheet through which the through-holes have been perforated is pressed down at a position where the green sheet almost touches the upper face of the lower base and the projections of the lower base penetrate through the through-holes of the green sheet. Then, the green sheet is taken up so as to peel off from the upper face of the lower base in removing the green sheet through which the through-holes have been perforated from the lower base. However, to date, there has been a problem that the green sheet whose rigidity is poor may cause undesirable deformation such as elongation and that positional precision of the through-holes deteriorates if the projections of the lower base interfere with the green sheet by hooking the green sheet for example.

### SUMMARY OF THE INVENTION

The present invention is provided in view of such actual situation of the conventional art, and a first object of the invention is to provide a through-hole machining apparatus for producing through-holes in a green sheet that enables one to readily prevent positional precision of through-holes from deteriorating after perforation and a second object the invention is to provide a through-hole machining method that enables one to readily prevent the positional precision of the through-holes from deteriorating after perforation.

As one solution for achieving the first object, an inventive through-hole machining apparatus for producing through-holes in a green sheet is adapted so as to include a lower base having projections for perforating through-holes at a plurality of spots of an upper face thereof, a releasing plate having a plurality of clearance holes into which a group of projections is idly inserted and removably set on the upper face of the lower base, an upper base having a plurality of transmission holes for inserting the group of projections and a pressurizing roller for pressing the upper base toward the releasing plate, and is arranged so as to perforate through-holes through the green sheet by the projections by pressing the green sheet down toward the releasing plate by applying pressure by the pressurizing roller while interposing the ceramic green sheet between the lower and upper bases.

The through-hole machining apparatus in which the releasing plate is thus removably set on the upper face of the lower base allows the green sheet to be readily removed from the lower base together with the releasing plate because the green sheet through which the through-holes have been perforated is set on the releasing plate. That is, because the through-hole machining apparatus allows the green sheet whose rigidity is poor to be pulled out of the group of projections of the lower base while supporting the green sheet by the releasing plate, it becomes easy to avoid the projections from interfering with the green sheet in pulling out the green sheet. Therefore, it becomes possible to readily carry out the work for taking the green sheet out of the lower base without causing undesirable deformation such as elongation and to effectively prevent the positional precision of the through-holes from deteriorating after the perforation.

Preferably, such through-hole machining apparatus is arranged so that the releasing plate is made of a magnetic material and an electromagnet that is capable of adsorbing the releasing plate is attached to the lower base. Then, the releasing plate may be closely contacted with the upper face of the lower base by magnetic force of the electromagnet, preventing the releasing plate from wrinkling and allowing the green sheet to be set on the releasing plate in flat. The positional precision of the through-holes after the perforation may be improved further when the upper base is also made of a magnetic material in this case because the upper base is attracted to the upper face of the lower base via the green sheet and the releasing plate by the magnetic force of the electromagnet.

Further, as another solution for achieving the first object, a through-hole machining apparatus for producing through-holes in a green sheet of the invention is adapted so as to include a lower base having projections for perforating through-holes at a plurality of spots of an upper face thereof, a releasing layer made of an elastic member laid on a region of the lower base except of the group of projections, an upper base having a plurality of transmission holes for inserting the group of projections and a pressurizing roller for pressing the upper base toward the releasing layer, and is arranged so as to perforate through-holes through the green sheet by the projections by pressing the green sheet down toward the releasing layer by applying pressure by the pressurizing roller while interposing the ceramic green sheet between the lower and upper bases.

In the through-hole machining apparatus in which the releasing layer made of the elastic member is thus laid on the upper face of the lower base, while the releasing layer is elastically compressed when the upper base is pressed and the green sheet is pressed down, the releasing layer pushes up the green sheet by its own elasticity when the pressure is removed, so that a degree of insertion of the projections of the lower base into the through-holes is remarkably reduced after the perforation. Therefore, a possibility of interference with the green sheet caused by the projections in taking the green sheet out of the lower base becomes low, and it becomes possible to readily carry out the work for taking the green sheet out of the lower base without causing undesirable deformation such as elongation and to effectively prevent the positional precision of the through-holes from deteriorating after the perforation.

Further, although the lower base may be any type of lower base as long as it has the group of projections for perforating through-holes at a plurality of spots on the upper face thereof in the through-hole machining apparatus described above, it is preferable if the lower base is composed of a die thin plate provided with a group of projections, a supporting flat plate made of a porous material for supporting the die thin plate and an adsorption bed capable of adsorbing the die thin plate on the supporting flat plate, because plane precision of the die thin plate having the group of projections may be remarkably improved because suction force from the adsorption bed evenly acts on the whole back face of the die thin plate through the porous supporting flat plate. If the die thin plate is formed by an additive method using electoless plating and a frame is attached around the die thin plate at this time, the group of projections whose radial dimension is small may be precisely formed on the die thin plate and the die thin plate may be readily and removably attached to the adsorption bed by utilizing the frame.

Further, as one solution for achieving the second object, a through-hole machining method of a green sheet is adapted so as to include a releasing plate attaching step of removably setting a releasing plate having a plurality of clearance holes into which a group of projections may be idly inserted on a lower base having the projections at a plurality of spots on an upper face thereof, a green sheet sandwiching step of interposing the green sheet between the lower base and an upper base by setting the upper base having a plurality of transmission holes for inserting the group of projections on the ceramic green sheet set on the lower base after the releasing plate attaching step, a through-hole perforating step of punching the green sheet by the projections to perforate through-holes by pressing the upper base by a pressurizing roller to press the green sheet down toward the releasing plate after the green sheet sandwiching step and a green sheet releasing step of taking the green sheet out of the lower base together with the releasing plate after the through-hole perforating step.

Because the green sheet may be readily removed from the lower base together with the releasing plate after perforating the through-holes by thus removably setting the releasing plate in advance on the upper face of the lower base, the green sheet whose rigidity is poor may be pulled out of the group of projections of the lower base while supporting the green sheet by the releasing plate, avoiding an interference with the green sheet caused by the projections in pulling out the green sheet. Therefore, it becomes possible to readily carry out the work for taking the green sheet out of the lower base without causing undesirable deformation such as elongation and to effectively prevent the positional precision of the through-holes from deteriorating after the perforation.

Preferably, such through-hole machining method includes a releasing plate adsorbing step of adsorbing the releasing plate to the lower base by energizing a coil of an electromagnet attached to the lower base between the releasing plate attaching step and the green sheet sandwiching step. Thereby, it becomes possible to prevent the releasing plate from wrinkling and to set the green sheet on the releasing plate in flat because the releasing plate set on the lower base closely contacts with the upper face of the lower base by the magnetic force of the electromagnet.

Further, as another solution for achieving the second object, a through-hole machining method of a green sheet is adapted so as to include a releasing layer laying step of laying a releasing layer made of an elastic member on a region except of a group of projections of a lower base having the projections at a plurality of spots on an upper face thereof, a green sheet sandwiching step of interposing the green sheet between the lower base and an upper base by setting the upper base having a plurality of transmission holes for inserting the group of projections on the ceramic green sheet set on the lower base after the releasing layer laying step, a through-hole perforating step of punching the green sheet by the projections to perforate through-holes by pressing the upper base by a pressurizing roller to press the green sheet down toward the releasing layer after the green sheet sandwiching step, a frame attaching step of attaching a frame to the lower base so as to surround the green sheet after the through-hole perforating step, an adhesive sheet pasting step of pasting an adhesive sheet that covers the upper face of the green sheet to the green sheet and the frame after the frame attaching step and a green sheet releasing step of taking the green sheet out of the lower base together with the frame and the adhesive sheet after the adhesive sheet pasting step.

If the releasing layer made of the elastic member is thus laid on the upper face of the lower base in advance, the releasing layer that is elastically compressed by the pressure at the time of the through-hole perforating step pushes up the green sheet by its own elasticity when the pressure is removed. Therefore, a degree of insertion of the projections of the lower base into the through-holes is remarkably reduced after the perforation and the possibility of interference with the green sheet which is otherwise caused by the projections of the lower base is lowered in the green sheet releasing step. Then, it becomes possible to readily carry out the work for taking the green sheet out of the lower base without causing undesirable deformation such as elongation. Still more, because the green sheet pasted by the adhesive sheet may be held by the frame, the work efficiency in the green sheet releasing step is extremely improved, effectively preventing the positional precision of the through-holes from deteriorating after the perforation. Furthermore, because the upper face of the green sheet through which the through-holes are perforated is covered by the adhesive sheet, it becomes possible to suppress the green sheet from contracting due to natural drying, preventing the positional precision of the through-holes from deteriorating also in this point.

As described above, the green sheet through which the through-holes have been perforated is set on the releasing plate in the inventive through-hole machining apparatus in which the releasing plate is removably set on the upper face of the lower base, so that the green sheet whose rigidity is poor may be pulled out of the group of projections of the lower base while being supported by the releasing plate and the interference with the green sheet which is otherwise caused by the projections may be readily avoided in pulling out the green sheet. Therefore, it becomes possible to readily carry out the work for taking the green sheet out of the lower base without causing undesirable deformation such as elongation and to effectively prevent the positional precision of the through-holes from deteriorating after the perforation.

Still more, while the releasing layer is elastically compressed when the upper base is pressed to press the green sheet down in the inventive through-hole machining apparatus in which the releasing layer made of the elastic member is laid on the upper face of the lower base, the releasing layer pushes up the green sheet by its own elasticity when the pressure is removed and the degree of insertion of the projections of the lower base into the through-holes is remarkably reduced after the perforation. Therefore, the possibility of interference with the green sheet which is otherwise caused by the projections is lowered and it becomes possible to readily carry out the work for taking the green sheet out of the lower base without causing undesirable deformation such as elongation and to effectively prevent the positional precision of the through-holes from deteriorating after the perforation.

Furthermore, according to the inventive through-hole machining method that is arranged so that the releasing plate is removably set in advance on the upper face of the lower base and the green sheet is removed from the lower base together with the releasing plate after perforating the through-holes, the green sheet whose rigidity is poor may be pulled out of the group of projections of the lower base while being supported by the releasing plate and the interference with the green sheet which is otherwise caused by the projections may be readily avoided in pulling out the green sheet. Therefore, it becomes possible to readily carry out the work for taking the green sheet out of the lower base without causing undesirable deformation such as elongation and to effectively prevent the positional precision of the through-holes from deteriorating after the perforation.

Still more, according to the inventive through-hole machining method adapted so as to lay the releasing layer made of the elastic member on the upper face of the lower base and so as to paste the adhesive sheet to the green sheet and the frame attached so as to surround the green sheet, the releasing layer pushes up the green sheet by its own elasticity when the pressure is removed and the degree of insertion of the projections of the lower base into the through-holes is remarkably reduced after the perforation and the possibility of the interference with the green sheet which is otherwise caused by the projections is lowered in the green sheet releasing step. Therefore, it becomes possible to readily carry out the work for taking the green sheet out of the lower base without causing undesirable deformation such as elongation. Still more, because the green sheet pasted with the adhesive sheet may be held by the frame, the work efficiency in the green sheet releasing step is extremely improved and hence it becomes possible to effectively prevent the positional precision of the through-holes from deteriorating after the perforation. Furthermore, because the upper face of the green sheet after the perforation is covered by the adhesive sheet, it becomes possible to suppress the green sheet from contracting due to natural dying, improving the effect of preventing the positional precision of the through-holes from deteriorating also from this point.

### BRIEF DESCRIPTION OF THE DRAWINGS

FIGS. 1A through 1D are pictorial stepwise representations showing a procedure for forming through-holes through a green sheet by a machining apparatus of a first exemplary embodiment of the invention.

FIG. 2 is a section view of a main part of a through-hole perforating step in the first exemplary embodiment.

FIG. 3 is a pictorial representation for explaining a step of interposing a green sheet of a machining apparatus according to a second exemplary embodiment of the invention.

FIG. 4 is a pictorial representation for explaining a through-hole perforating step in the second exemplary embodiment.

FIGS. 5A through 5C are pictorial stepwise representations showing a procedure for forming through-holes through a green sheet by a machining apparatus of a third exemplary embodiment of the invention.

FIGS. 6A through 6C are pictorial stepwise representations showing a procedure for forming through-holes through the green sheet by the machining apparatus of the third exemplary embodiment.

FIG. 7 is a section view of a main part of a lower base in the third exemplary embodiment.

FIG. 8 is a pictorial representation for explaining the lower base provided for the machining apparatus according to a forth exemplary embodiment of the invention.

FIG. 9 is a section view of a main part of the lower base.

### DESCRIPTION OF THE PREFERRED EMBODIMENTS

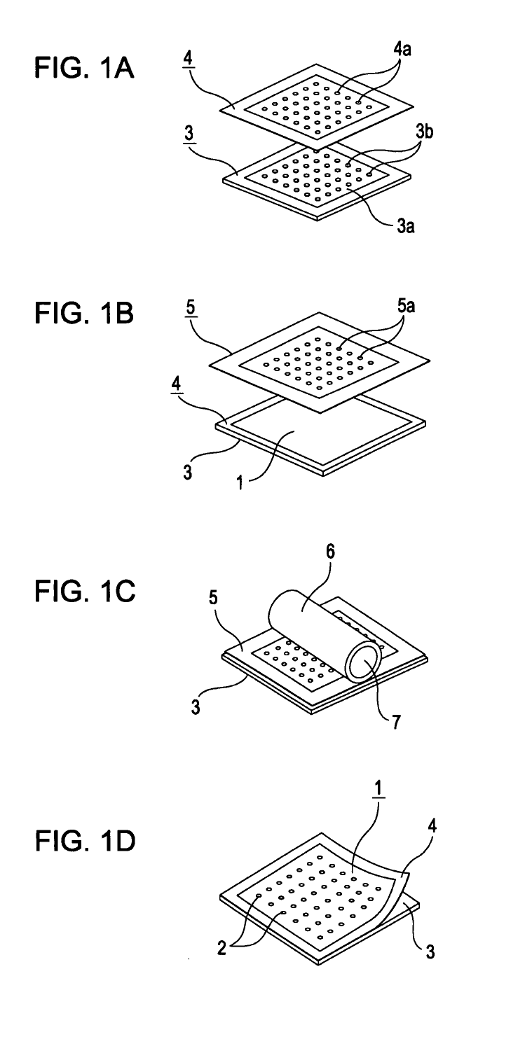

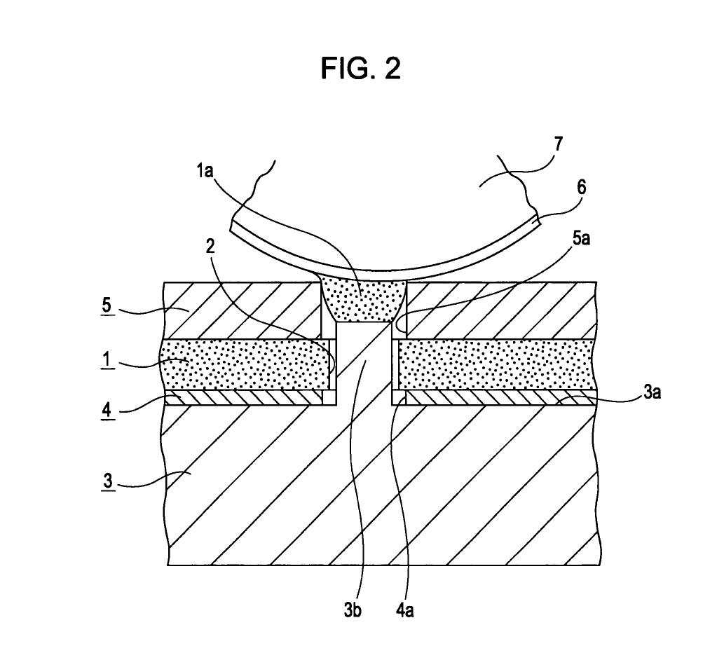

Preferred embodiments of the invention will be explained with reference to the drawings, wherein FIGS. 1A through 1D are pictorial stepwise representations showing a procedure for forming through-holes through a green sheet using a machining apparatus according to a first exemplary embodiment of the invention and FIG. 2 is a section view of a main part of a through-hole perforating step in the first exemplary embodiment.

The through-hole machining apparatus shown in FIGS. 1 and 2 forms through-holes 2 through a ceramic green sheet 1 and is mainly composed of a lower base 3 that corresponds to a punch, a releasing plate 4 made of a metal thin plate such as stainless steel, an upper base 5 that corresponds to a die and a pressurizing roller 7 attached with an adhesive layer 6 around an outer peripheral surface thereof. The lower base 3 is provided with projections 3b for perforating through-holes at a plurality of spots on an upper face 3a thereof, except on outer edges thereof. The releasing plate 4 is provided with clearance holes 4a at a plurality of spots corresponding to the group of projections 3b. The releasing plate 4 is removably set on the upper face 3a of the lower base 3 in a state in which the corresponding projections 3b are inserted into the clearance holes 4a. The upper base 5 is provided with a plurality of transmission holes 5a for inserting the group of projections 3b of the lower base 3. The pressurizing roller 7 is used to press the upper base 5 toward the releasing plate 4 in a state in which the green sheet 1 is set on the lower base 3.

A procedure for forming the through-holes 2 through the green sheet 1 by using the machining apparatus constructed as described above will be explained. At first, the releasing plate 4 is set on the upper face 3a of the lower base 3 while aligning the group of clearance holes 4a with the group of projections 3b as shown in FIG. 1A (releasing plate setting step). Next, the green sheet 1 is interposed between the lower base 3 and the upper base 5 by aligning and setting the green sheet 1 and the upper base 5 sequentially on the lower base 3 as shown in FIG. 1B (green sheet sandwiching step). Next, the upper base 5 is pressed by the pressurizing roller 7 so as to press the green sheet 1 down toward the releasing plate 4 to punch the green sheet 1 by the projections 3b and to perforate the through-holes 2 as shown in FIG. 1C (through-hole perforating step). Because a punched chip 1a of the green sheet 1 punched by the projections 3b is pushed into the transmission hole 5a of the upper base 5 at this time as shown in FIG. 2, the punched chip 1a may be removed by the adhesive layer 6 attached around the outer peripheral surface of the pressurizing roller 7. Then, after evacuating the upper base 5 from the lower base 3, the green sheet 1 is removed from the lower base 3 together with the releasing plate 4 by lifting up the releasing plate 4 from its corner as shown in FIG. 1D (green sheet releasing step).

Thus, according to this exemplary embodiment, the through-holes 2 are perforated through the green sheet 1 by the machining apparatus in which the releasing plate 4 is removably set on the upper face 3a of the lower base 3 and the green sheet 1 is set on the releasing plate 4 as shown in FIG. 2 that shows a state in which the through-hole is just perforated, so that the green sheet 1 whose rigidity is poor may be removed from the lower base 3 while setting the green sheet 1 on the releasing plate 4 made of a metal thin plate. That is, the green sheet 1 may be pulled out of the group of projections 3b of the lower base 3 while being stably held by the releasing plate 4 in the aforementioned green sheet releasing step, so that the projections 3b are unlikely to interfere with the green sheet 1 in pulling out the green sheet 1 and the removal of the green sheet 1 from the lower base 3 may be readily carried out without causing undesirable deformation such as elongation. Thus, it becomes possible to effectively prevent the positional precision of the through-holes 2 from deteriorating after the perforation. Moreover, because the green sheet 1 thus removed from the lower base 3 may be conveyed to a next step while being set on the releasing plate 4, there is also almost no such possibility that the green sheet 1 is deformed during its conveyance.

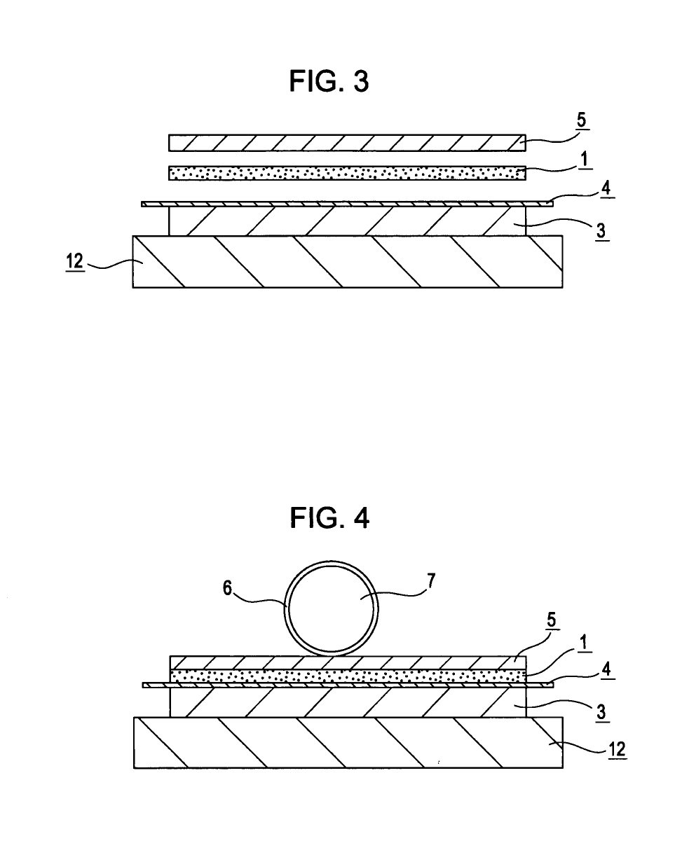

FIG. 3 is a pictorial representation of the step for sandwiching the green sheet of the machining apparatus according to a second exemplary embodiment of the invention and FIG. 4 is a pictorial representation of the through-hole perforating step in the second exemplary embodiment. Parts therein corresponding to those in FIGS. 1 and 2 will be denoted by the same reference numerals to avoid overlapped explanation.

The through-hole machining apparatus shown in FIGS. 3 and 4 is different from that shown in the aforementioned first exemplary embodiment in that an electromagnet 12 is disposed under the lower base 3 and that the releasing plate 4 and the upper base 5 are made of a ferromagnetic material such as nickel or iron. The electromagnet 12 is a coil wound around a core that generates magnetic force when the coil is energized. The releasing plate 4 is made of a nickel thin plate whose thickness is around 30 μm for example and is provided with the clearance holes 4a at a plurality of spots corresponding to the group of projections 3b of the lower base 3 in the same manner as the first exemplary embodiment. The upper base 5 is made of a nickel thin plate whose thickness is around 50 μm for example and is provided with the plurality of transmission holes 5a for inserting the group of projections 3b of the lower base 3 in the same manner as the first exemplary embodiment.

A through-hole machining method of the present exemplary embodiment is basically the same as the first exemplary embodiment explained with reference to FIG. 1, except that a releasing plate adsorbing step is added between the releasing plate setting step and the green sheet sandwiching step. That is, the releasing plate 4 is set on the upper face 3a of the lower base 3 while aligning the group of clearance hole 4a with the group of projections 3b at first as shown in FIG. 1A (releasing plate attaching step). At this time, the coil of the electromagnet 12 is not energized, so that the releasing plate 4 may be set readily on the upper face 3a of the lower base 3. Next, the coil of the electromagnet 12 is energized to generate magnetic force and to closely contact the releasing plate 4 with the upper face of the lower base 3 by means of the magnetic force (releasing plate adsorbing step). Thereby, wrinkles that might be generated in the thin releasing plate 4 are flattened and the releasing plate 4 becomes flat in conformity with the upper face of the lower base 3. Next, the green sheet 1 is interposed between the lower base 3 and the upper base 5 by aligning and setting the green sheet 1 and the upper base 5 sequentially on the lower base 3 as shown in FIGS. 1B and 3 (green sheet sandwiching step). The coil of the electromagnet 12 is energized also at this time, so that the upper base 5 is attracted to the upper face of the lower base 3 by the magnetic force of the electromagnet 12 via the green sheet 1 and the releasing plate 4. Next, the upper base 5 is pressed by the pressurizing roller 7 to press the green sheet 1 down toward the releasing plate 4 to punch the green sheet 1 by the projections 3b and to perforate the through-holes 2 as shown in FIG. 1C and FIG. 4 (through-hole perforating step). Because the punched chip 1a of the green sheet 1 punched by the projections 3b is pushed into the transmission hole 5a of the upper base 5 at this time as shown in FIG. 2, the punched chip 1a may be removed by the adhesive layer 6 attached around the outer peripheral surface of the pressurizing roller 7. Then, the upper base 5 is evacuated from the lower base 3 after de-energizing the coil of the electromagnet 12 and finally, the green sheet 1 is removed from the lower base 3 together with the releasing plate 4 by lifting up the releasing plate 4 from its corner as shown in FIG. 1D (green sheet releasing step).

Thus, according to the exemplary embodiment, the releasing plate adsorbing step is added between the releasing plate attaching step and the green sheet sandwiching step so that the releasing plate 4 closely contacts the upper face of the lower base 3 by the magnetic force generated by the electromagnet 12, so that even if the releasing plate 4 wrinkles in the releasing plate attaching step and is wavy, the wrinkles are flattened in the releasing plate adsorbing step and the releasing plate 4 becomes flat. Then, the green sheet 1 may be set flat on the releasing plate 4 in the green sheet sandwiching step. Moreover, because the upper base 5 is attracted to the upper face of the lower base 3 by the magnetic force of the electromagnet 12 via the green sheet 1 and the releasing plate 4 in the through-hole perforating step, the three parts of the releasing plate 4, the green sheet 1 and the upper base 5 will not be misaligned with respect to the lower base 3, allowing the positional precision of the through-holes 2 after the perforation to be markedly improved.

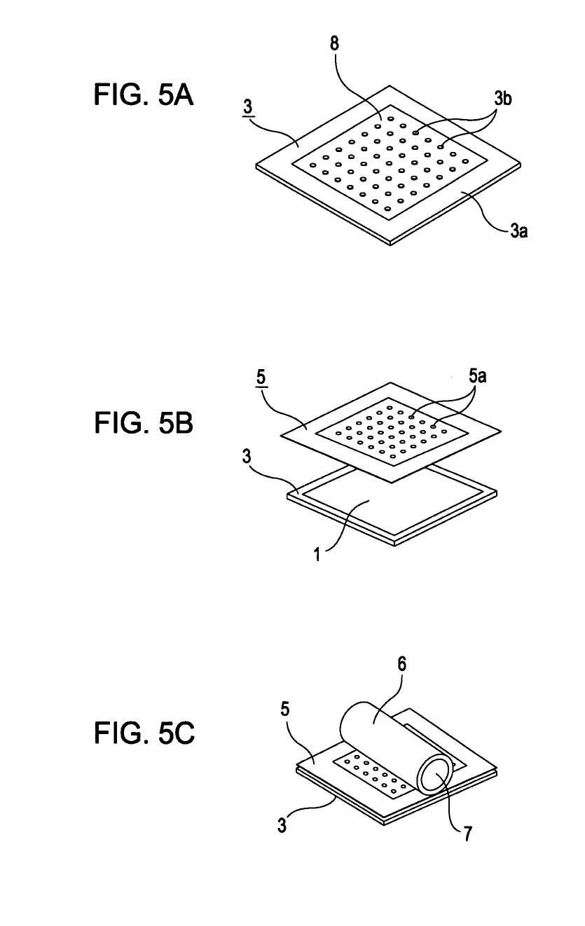

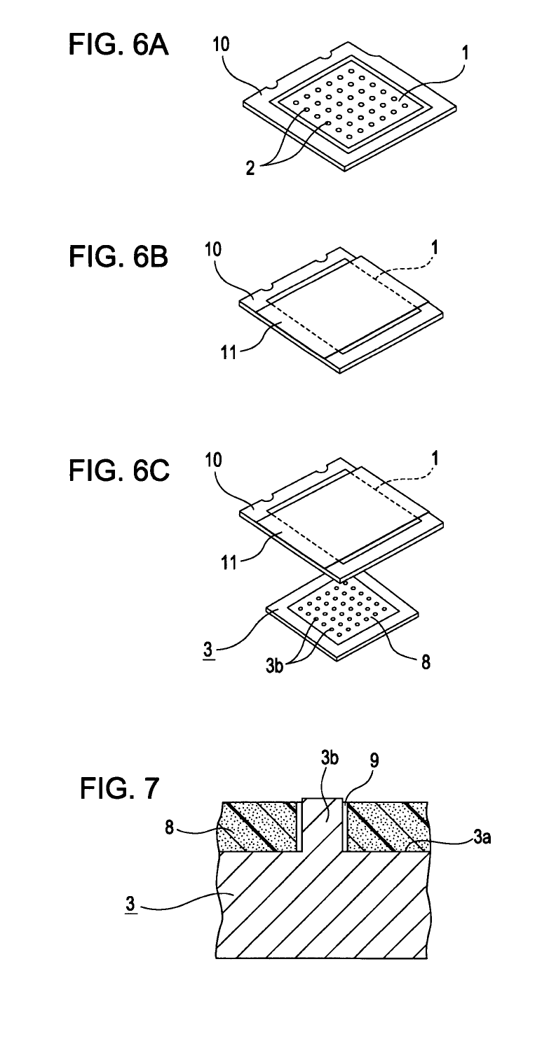

FIGS. 5A through 5C as well as FIGS. 6A through 6C are pictorial stepwise representations showing a procedure for forming through-holes through a green sheet by a machining apparatus of a third exemplary embodiment of the invention and FIG. 7 is a section view of a main part of the lower base of the third exemplary embodiment. Parts therein corresponding to those in FIGS. 1 and 2 will be denoted by the same reference numerals to avoid overlapped explanation.

The through-hole machining apparatus shown in FIGS. 5 through 7 is markedly different from that of the aforementioned first exemplary embodiment in that a releasing layer 8 made of an elastic member such as urethane foam is laid on the upper face 3a of the lower base 3. This releasing layer 8 is laid in a region that does not include the group of projections 3b of the upper face 3a of the lower base 3 and a gap 9 is created between each projection 3b and the releasing layer 8. Moreover, work efficiency and reliability are improved in the present exemplary embodiment by using a frame 10 attached to the lower base 3 so as to surround the green sheet 1, together with an adhesive sheet 11 pasted to the green sheet 1 and the frame 10.

A procedure of a through-hole machining method of the present exemplary embodiment will be explained. At first, the releasing layer 8 is laid in the region except of the group of projections 3b of the upper face 3a of the lower base 3 by means of coating of urethane foam as shown in FIG. 5A (releasing layer laying step). Next, the green sheet 1 is interposed between the lower base 3 and the upper base 5 by aligning and setting the green sheet 1 and the upper base 5 sequentially on the lower base 3 as shown in FIG. 5B (green sheet sandwiching step). Next, the upper base 5 is pressed by the pressurizing roller 7 to press the green sheet 1 down toward the releasing layer 8 to punch the green sheet 1 by the projections 3b and to perforate the through-holes 2 as shown in FIG. 5C (through-hole perforating step). At this time, punched chips of the green sheet 1 punched by the projections 3b are removed by the adhesive layer 6 attached around the outer peripheral surface of the pressurizing roller 7. Then, after evacuating the upper base 5 from the lower base 3, the frame 10 is attached to the lower base 3 so as to surround the green sheet 1 as shown in FIG. 6A (frame attaching step). Next, the adhesive sheet 11 for covering the upper face of the green sheet 1 is pasted to the green sheet 1 and the frame 10 as shown in FIG. 6B (adhesive sheet pasting step). After that, the green sheet 1 is removed from the lower base 3 together with the green sheet 19 and the adhesive sheet 11 as shown in FIG. 6C (green sheet releasing step).

Thus, the present exemplary embodiment is arranged such that the green sheet 1 is pushed up by elasticity of the releasing layer 8 when the pressure in the through-hole perforating step is removed by laying the releasing layer 8 made of an elastic member in advance on the upper face 3a of the lower base 3, so that a degree of insertion of the projections 3b into the through-holes 2 is remarkably reduced after the perforation. Therefore, there is almost no possibility that the projections 3b interfere with the green sheet 1 in the green sheet releasing step and it becomes possible to readily carry out the work for taking the green sheet 1 out of the lower base 3 without causing undesirable deformation such as elongation. Still more, because the frame 10 can hold the green sheet 1 to which the adhesive sheet 11 is pasted, the work efficiency in the green sheet releasing step is remarkably improved, thus effectively preventing the positional precision of the through-holes 2 from deteriorating after the perforation. Still more, because the upper face of the green sheet 1 through which the through-holes 2 have been perforated is covered by the adhesive sheet 11, it is possible to suppress the green sheet 1 from contracting due to natural drying, improving the effect of preventing the positional precision of the through-holes 2 from deteriorating also in this point. Still more, the green sheet 1 removed from the lower base 3 is conveyed to a next step while being held by the frame 10, there is almost no possibility of deforming the green sheet 1 during its conveyance.

It is noted that although the case of using the frame 10 together with the adhesive sheet 11 has been explained in the third exemplary embodiment, it is possible to prevent the deterioration of the positional precision of the through-holes 2 after the perforation without using the both. That is, because the green sheet 1 is pushed up by the elasticity of the releasing layer 8 after the through-hole perforating step and the degree of insertion of the projections 3b into the through-holes 2 is remarkably reduced, undesirable deformation such as elongation hardly occurs even if the green sheet 1 is peeled out of the lower base 3 as it is in the green sheet releasing step.

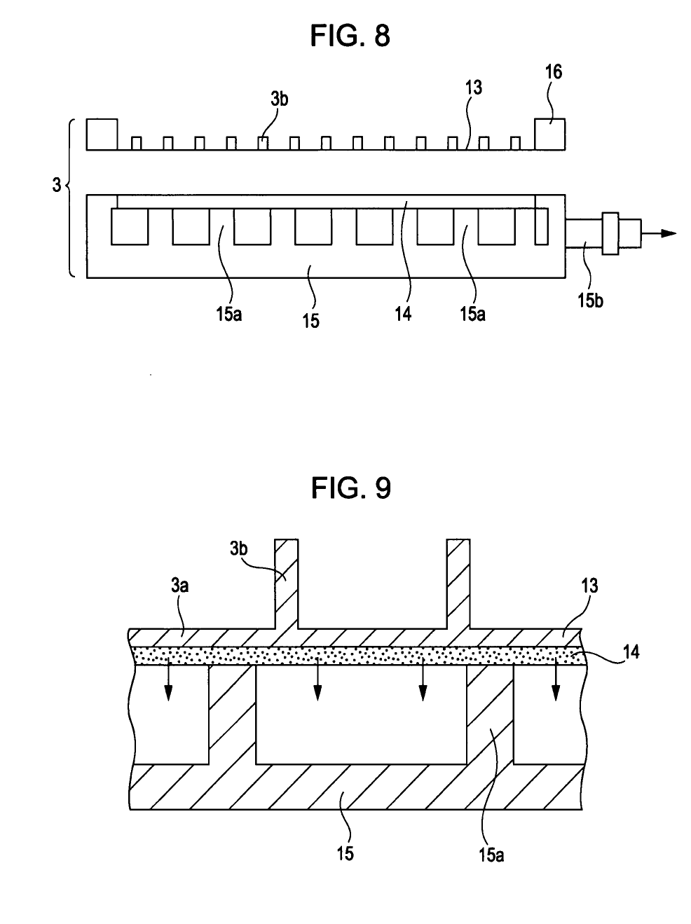

FIG. 8 is a pictorial representation for explaining the lower base provided for the machining apparatus according to a forth exemplary embodiment of the invention and FIG. 9 is a section view of a main part of the lower base. Parts therein corresponding to those in FIGS. 1 and 2 will be denoted by the same reference numerals to avoid overlapped explanation.

The lower base 3 of the through-hole machining apparatus shown in FIGS. 8 and 9 is composed of a die thin plate 13 provided with the group of projections 3b for perforating through-holes and an adsorption bed 15 on which a supporting flat plate 14 is set and is arranged so that the die thin plate 13 is supported on the supporting flat plate 14. The die thin plate 13 is what is formed by an additive method using electroless plating such as nickel plating and is provided with the group of projections 3b of about 150 μm in height from the upper face 3a of the base part of about 30 μm in thickness for example. The die thin plate 13 is attached to the frame 16 by its periphery while tensioning the die thin plate 13, so that the die thin plate 13 may be carried readily by the frame 16. The supporting flat plate 14 is made of a porous material such as stainless steel whose upper face is mirror-finished. The adsorption bed 15 is provided with a plurality of columns 15a erecting within that and the supporting flat plate 14 is set horizontally on the columns 15a. A suction valve 15b is attached on one side of the adsorption bed 15 so that air within the adsorption bed 15 is suctioned through the suction valve 15b.

When the air within the adsorption bed 15 is suctioned through the suction valve 15b after setting the die thin plate 13 on the supporting flat plate 14 by utilizing the frame 16 in the lower base 3 of the present exemplary embodiment, the suction force from the adsorption bed 15 acts evenly on the whole back face of the die thin plate 13 through the porous supporting flat plate 14, so that the die thin plate 13 may be closely contacted with the upper face of the mirror-finished supporting flat plate 14. Accordingly, when the group of projections 3b whose radial dimension is small is formed on the die thin plate 13 in high precision by the additive method, the plane precision may be remarkably improved by closely contacting the die thin plate 13 on the upper face of the supporting flat plate 14.

The lower base 3 thus constructed is applicable to any of the through-hole machining apparatuses of the first through third exemplary embodiments. When it is applied to the through-hole machining apparatus of the first exemplary embodiment, the die thin plate 13 is adsorbed to the supporting flat plate 14 by operating the adsorption bed 15 so as to suction air and the whole steps from the releasing plate attaching step through the green sheet releasing step may be carried out while keeping this state. Then, when the suctioning operation of the adsorption bed 15 is stopped after finishing the whole process, the operation of adsorbing the die thin plate 13 to the supporting flat plate 14 is released, so that the die thin plate 13 may be readily removed from the supporting flat plate 14 by utilizing the frame 16.

What is claimed is:

1. A through-hole machining apparatus for producing through-holes in a green sheet, comprising:
a lower base having projections for perforating through-holes at a plurality of spots of an upper face thereof;
a releasing plate having a plurality of clearance holes into which a group of said projections is inserted and removably set on the upper face of said lower base;
an upper base having a plurality of transmission holes for inserting said group of projections; and
a pressurizing roller for pressing said upper base toward said releasing plate:
wherein said through-hole machining apparatus is adapted so as to perforate through-holes through said green sheet by said projections by pressing said green sheet down toward said releasing plate by applying pressure using said pressurizing roller while interposing said ceramic green sheet between said lower and upper bases.

2. The through-hole machining apparatus for a through-hole machining apparatus according to claim 1, wherein said releasing plate is made of a magnetic material and an electromagnet that is capable of adsorbing said releasing plate is attached to said lower base.

3. The through-hole machining apparatus for producing through-holes in a green sheet according to claim 2, wherein said upper base is made of a magnetic material.

4. A through-hole machining apparatus for producing through-holes in a green sheet, comprising:
a lower base having projections for perforating through-holes at a plurality of spots of an upper face thereof;
a releasing layer made of an elastic member laid on a region of said lower base that does not include the group of said projections;
an upper base having a plurality of transmission holes for inserting said group of projections; and
a pressurizing roller for pressing said upper base toward said releasing layer:
wherein said through-hole machining apparatus is adapted so as to perforate through-holes through said green sheet by said projections by pressing said green sheet down toward said releasing plate by applying pressure using said pressurizing roller while interposing said ceramic green sheet between said lower and upper bases.

5. The through-hole machining apparatus for producing through-holes in a green sheet according to claim 1, wherein said lower base comprises a die thin plate provided with said group of projections, a supporting flat plate made of a porous material for supporting said die thin plate and an adsorption bed capable of adsorbing said die thin plate on said supporting flat plate.

6. The through-hole machining apparatus for producing through-holes in a green sheet, wherein said die thin plate is formed by an additive method using electroless plating and a frame is attached around said die thin plate.

7. A through-hole machining method for a green sheet, comprising:
a releasing plate attaching step of removably setting a releasing plate having a plurality of clearance holes into which a group of projections may be inserted on a lower base having said projections at a plurality of spots on an upper face thereof;
a green sheet sandwiching step of interposing said green sheet between said lower base and an upper base by setting said upper base having a plurality of transmission holes for inserting said group of projections on said ceramic green sheet set on said lower base after said releasing plate attaching step;
a through-hole perforating step of punching said green sheet by said projections to perforate through-holes by pressing said upper base using a pressurizing roller to press said green sheet down toward said releasing plate after said green sheet sandwiching step; and
a green sheet releasing step of taking said green sheet out of said lower base together with said releasing plate after said through-hole perforating step.

8. The through-hole machining method for a green sheet according to claim 7, further comprising a releasing plate adsorbing step of adsorbing said releasing plate to said lower base by energizing a coil of an electromagnet attached to said lower base between said releasing plate attaching step and said green sheet sandwiching step.

9. A through-hole machining method of a green sheet, comprising:
a releasing layer laying step of laying a releasing layer made of an elastic member on a region that does not include a group of projections of a lower base having said projections at a plurality of spots on an upper face thereof;
a green sheet sandwiching step of interposing said green sheet between said lower base and an upper base by setting said upper base having a plurality of transmission holes for inserting said group of projections on said ceramic green sheet set on said lower base after said releasing layer laying step;
a through-hole perforating step of punching said green sheet by said projections to perforate through-holes by pressing said upper base using a pressurizing roller to press said green sheet down toward said releasing layer after said green sheet sandwiching step;
a frame attaching step of attaching a frame to said lower base so as to surround said green sheet after said through-hole perforating step;
an adhesive sheet pasting step of pasting an adhesive sheet that covers the upper face of said green sheet to said green sheet and said frame after said frame attaching step; and
a green sheet releasing step of taking said green sheet out of said lower base together with said frame and said adhesive sheet after said adhesive sheet pasting step.
a releasing layer made of an elastic member laid on a region of said lower base except of the group of said projections;
an upper base having a plurality of transmission holes for inserting said group of projections; and
a pressurizing roller for pressing said upper base toward said releasing layer:
wherein said through-hole machining apparatus is adapted so as to perforate through-holes through said green sheet by said projections by pressing said green sheet down toward said releasing plate by applying pressure using said pressurizing roller while interposing said ceramic green sheet between said lower and upper bases.
